(19) United States
(12) Patent Application Publication
(10) Pub. No.: US 2025/0251000 A1
(43) Pub. Date: Aug. 7, 2025

(54) COMPOSITE INSERTS AND MANUFACTURING METHOD THEREFOR

(71) Applicant: Arris Composites Inc., Berkeley, CA (US)

(72) Inventors: J. Scott PERKINS, Oakland, CA (US); Daniel MELVIN, Larkspur, CA (US); Erick DAVIDSON, Piedmont, CA (US)

(21) Appl. No.: 19/037,651

(22) Filed: Jan. 27, 2025

Related U.S. Application Data
(60) Provisional application No. 63/549,089, filed on Feb. 2, 2024.

(51) Int. Cl. F16B 5/01; B29C 70/24; B29C 70/46; B29K 71/00; B29K 105/08; B29L 31/00

(52) U.S. Cl. CPC F16B 5/01; B29C 70/24; B29C 70/462; B29K 2071/00; B29K 2105/0872; B29L 2031/727

(57) ABSTRACT

A fiber-composite sandwich-panel insert is a monolithic structure having a tubular body and a tapered head, wherein an axially aligned bore extends completely through the sandwich panel insert, the monolithic structure comprising a plurality of fibers in a resin matrix, wherein a first group of the plurality of fibers are disposed in the tubular body and have an axial alignment therein, and a second group of the plurality of fibers are disposed at least partially in the tapered head and have a spiral alignment therein.

### STATEMENT OF RELATED CASES

This specification claims priority of U.S. 63/549,089, which was filed on Feb. 2, 2024, and is incorporated by reference herein.

### FIELD OF THE INVENTION

The present invention relates to fiber-composite materials, such as for use in aerospace, among other applications.

### BACKGROUND

A panel comprising a sandwich structure of face sheets (typically aluminum or carbon-fiber-reinforced plastic) with a honeycomb core is widely used in aerospace for weight savings. Although the honeycomb core exhibits desirable bending stiffness over large spans, the size of the individual cells in the honeycomb renders the sandwich panels subpar in local compression.

Fasteners are often required to attach these sandwich panels to adjacent structure. The local point of compression from the fastener on the sandwich panel requires the presence of a “sandwich panel insert,” which extends through the honeycomb core to prevent the sandwich panel from being locally crushed.

In the art, these sandwich panel inserts are made of metal, because conventional plastics do not possess sufficient compressive strength to bear the load from the fastener. However, the weight of the metal inserts negatively impacts fuel economy during flight. The art would therefore benefit from a sandwich panel insert comprising a material (e.g., carbon-fiber composites, etc.) that is lighter than a typical metal insert, yet capable of withstanding the compressive load imparted by the fastener it receives.

### SUMMARY

Some embodiments of the invention provide a fiber-composite sandwich-panel insert (“SPI”), a feed constituent for its manufacture, and a method for its manufacture. The SPI is particularly useful in conjunction with panels having a honeycomb core, such as those used in aerospace applications.

Sandwich panels have traditionally used metal SPIs, which receive fasteners such as bolts, for attaching the panels to adjacent structure. To attach a sandwich panel to an adjacent structure, holes are drilled through the sandwich panel at the desired locations of the attachment points to the adjacent structure. SPIs are placed in the holes, and bolts are placed in the SPIs. The bolts are torqued down via a nut, etc., to affix the sandwich panel to the adjacent structure.

Once torqued, the bolts are in tension and the SPIs are in compression. The SPI withstands this compressive force, thus preventing the sandwich panel from being locally crushed.

It is well known that best mechanical properties for a given geometry of a fiber-composite part are attained when the fibers therein are aligned with the direction of principal stress vectors within the part, as arise from loading conditions. Consequently, in the straight, tubular body of the SPI, fibers are ideally axially (longitudinally) aligned to address the compressive stress arising in the tubular body.

The inventors recognized, however, that in the region of the tapered head of the SPI, the fibers should not be axially aligned. Rather, in the head of the SPI, the fibers should have a spiral alignment.

Consider that once the bolt in the SPI is tightened, a diagonal normal force arises at the head of the SPI. This results in a combination of a compressive axial stress and a hoop/tangential stress in the head of the SPI. Such stresses dictate a non-axial fiber alignment in the head region for best mechanical properties. Indeed, if the fibers within the SPI were axially aligned through its whole length, including the tapered head, the SPI might not be able to withstand those non-axial stresses. This would result in failure of the SPI at its head.

The spiraling fibers in the head of an SPI in accordance with the present teachings will exhibit components of axial and tangential orientation, which will more closely align (relative to axially aligned fibers) with the aforementioned non-axially aligned stresses arising in the head. The prior art does not raise this issue, nor provide any way to address it.

### BRIEF DESCRIPTION OF THE DRAWINGS

FIG. 1 depicts a conventional metal sandwich panel insert (“SPI”) in use with a sandwich panel.

FIG. 2 depicts a fiber-composite SPI in accordance with the present teachings.

FIG. 3 depicts an embodiment of a preform charge for making the fiber-composite SPI of FIG. 2.

FIG. 4 depicts an embodiment of a preform-charge fixture for making the preform charge of FIG. 3.

FIG. 5A depicts an embodiment of a compression-molding tool for use in making the fiber composite SPI of FIG. 2, wherein the tool is in a fully open state.

FIG. 5B depicts the compression-molding tool of FIG. 5A in fully closed out state.

FIG. 6 depicts a preform charge in the mold cavity of the molding tool of FIGS. 5A/5B.

FIG. 7 depicts a portion of the compression-molding tool during compression molding, wherein fibers and resin have filled the mold cavity.

FIG. 8 depicts an enlargement of the mold cavity of FIG. 7, showing further details of some of the fibers.

### DETAILED DESCRIPTION

All examples and conditional language recited herein are intended for pedagogical purposes to aid the reader in understanding the principles of the disclosure and the concepts contributed by the inventors to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Unless otherwise explicitly specified herein, the figures comprising the drawing are not drawn to scale.

The following terms are defined for use in this Specification, including the appended claims:
“Fiber” means an individual strand of material. A fiber has a length that is much greater than its diameter.
“Fiber bundle” means plural (typically multiples of one thousand) co-aligned fibers.
“Stiffness” in the context of a material means resistance to bending, as measured by Young's modulus.
“Tow” means a bundle of fibers (i.e., fiber bundle), and those terms are used interchangeably herein unless otherwise specified. Tows are typically available with fibers numbering in the thousands: a 1K (1000 fibers) tow, 4K (4000 fibers) tow, 8K (8000 fibers) tow, etc.
“Prepreg” means fibers that are impregnated with resin.
“Towpreg” means a fiber bundle (i.e., a tow) that is impregnated with resin.
“Preform” or “Fiber-bundle-based Preform” means an intentionally dimensioned and shaped bundle of fibers, that is impregnated with resin. The preforms are typically sourced from towpreg, but may be a portion of the output of resin-impregnation process. Preforms are preferably, but not necessarily, substantially circular/oval in cross section. A preform, as the term is used in this disclosure and the attached claims, is not a composite tape/ribbon, a sheet, or laminate. The aspect ratio (width to thickness) of tape or sheet is far greater than that of the fiber-bundle-based preform, the latter being about 1:1.
“Preform Charge” means an assemblage of fiber-bundle-based preforms that are at least loosely bound together (i.e., tacked) so as to maintain their position relative to one another. Neither the preforms, nor the resulting preform charge, are fully consolidated. That is, they cannot serve as a final part. Alternatively, a preform charge can be a 3D-printed structure, which may include a single, continuous length of filament, or multiple filaments (i.e., fiber discontinuities in the print path).
“Consolidate”, “consolidating”, or “consolidation” means, in the present context, that in a grouping of fibers/resin, such as plurality of preforms, void space is removed to the extent possible and as is acceptable for a final part. When consolidated, feed structures lose any unique or individual identity and any previously existing boundaries (between adjacent preforms or other feed structures) are lost. This usually requires significantly elevated pressure, which, for applicant's processes, is accomplished via fluid (e.g., gas, hydraulic oil, etc.) pressurization or the mechanical application of force, and elevated temperature (to soften/melt the resin). The pressure differential attainable via processes that utilize vacuum is wholly inadequate to consolidate applicant's preform-based feed constituents.
“Partial consolidation” means, in the present context, that in a grouping of fibers/resin, void space is not removed to the extent required for a final part. As an approximation, one to two orders of magnitude more pressure is required for full consolidation versus partial consolidation. As a further very rough generalization, to consolidate fiber-bundle-based preforms to about 80 percent of full consolidation requires only 20 percent of the pressure required to obtain full consolidation. Preform charges, for example, are not fully consolidated.
“Compatible” means, when used in reference to two or more polymer resins, that the resins will mix and bond with each other.
“About” or “Substantially” means +/−20% with respect to a stated figure or nominal value.
Other definitions may be provided elsewhere in this specification, in context.

Embodiments of the invention pertain to a fiber-composite, sandwich-panel insert (“SPI”), a feed constituent for its manufacture, and a method for its manufacture.

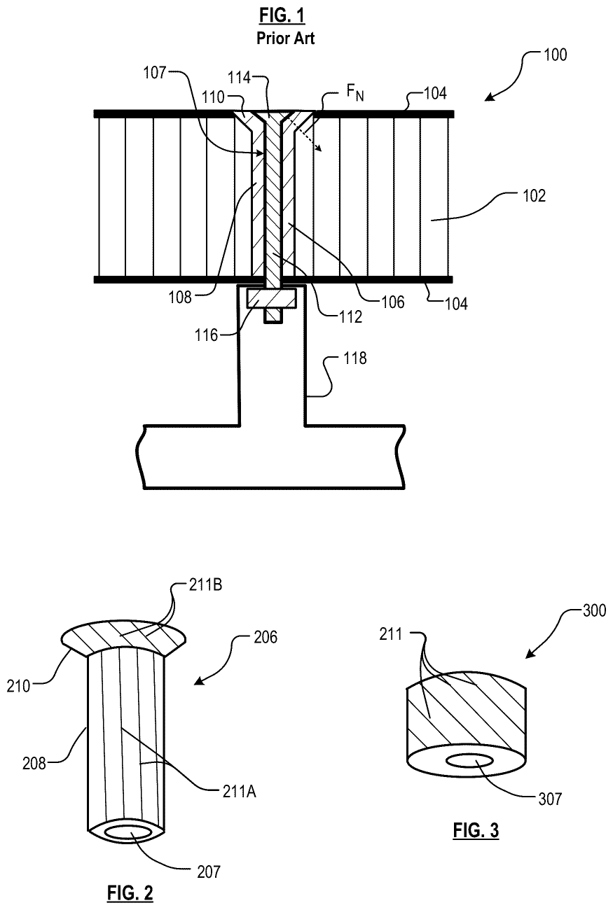

FIG. 1 depicts a conventional sandwich panel 100, having honeycomb core 102 (shown in side profile) that is disposed between two face sheets 104. Sandwich panel 100 includes conventional metal SPI 106, which includes axially aligned bore 107. The bore 107 receives a fastener, such as bolt 112, for attaching sandwich panel 100 to another structure, such as structure 118. Typically, a sandwich panel includes multiple SPIs 106, to provide multiple connection points to an adjacent structure.

Bolt 112 is torqued down via nut 116 to affix sandwich panel 100 to structure 118. Once torqued, bolt 112 is in tension, whereas SPI 106 is in compression. SPI 106 withstands this compressive force, thus preventing sandwich panel 100 from being locally crushed. The inventors recognized that at head 110 of SPI 106 and head 114 of bolt 112, the tapered geometry of these features results in a diagonal normal force FN, resulting in a combination of a compressive axial stress and a hoop/tangential stress in head 110 of SPI 106.

Best mechanical properties for a given geometry of a fiber-composite part are attained when the fibers therein are aligned with the direction of principal stresses everywhere throughout the part, as arise from loading conditions. Consequently, in accordance with the present teachings, for a fiber-composite SPI, fibers within the straight, tubular body of the SPI are ideally axially (longitudinally) aligned to address the compressive stress arising in that portion. And fibers within tapered head of the fiber-composite SPI have a spiral alignment, which more closely aligns (than axially aligned fibers) with the compressive axial stress and hoop stress arising therein.

FIG. 2 depicts fiber composite SPI 206 in accordance with the present teachings. Fiber composite SPI 206 has the same shape as legacy metal SPI 106 depicted in FIG. 1, and is a drop-in replacement for SPI 106. That is, SPI 206 has tubular body 208, a tapered head 210, and axially disposed bore 207. And a sandwich panel incorporating a fiber composite SPI in accordance with the present teachings, such as SPI 206, will appear the same as shown in FIG. 1, with the exception of the substitution of SPI 206 for SPI 106.

In the straight, tubular body 208 of SPI 206, fibers 211A have an axial (longitudinal) alignment. In tapered head 210 of the SPI, fibers 211B have a somewhat spiral alignment, thus having components of axial and tangential orientation, to align with compressive axial stress and hoop stress, respectively. It will be appreciated that there are many more fibers present in SPI 206 than shown in FIG. 2.

In accordance with the illustrative embodiment, a fiber-composite SPI, such as SPI 206, is formed via a compression-molding process, using a preform charge as the feed constituent. For this use, the preform charge has a cylindrical form factor with an axially aligned bore and a spiraled fiber alignment. FIG. 3 depicts preform charge 300, which is an embodiment of a preform charge that is suitable for forming a fiber-composite SPI, such as SPI 206.

As depicted in FIG. 3, preform charge 300 includes a plurality of fibers 211 having a substantially spiral alignment. It will be appreciated that there are many more fibers 211 present in preform charge 300 than are shown. Bore 307 is centrally located and axially aligned.

A preform charge, including preform charge 300, is formed from a plurality of fiber-bundle-based (FBB) preforms. The FBB preforms are typically formed from a continuous bundle of resin-impregnated fibers, sourced either from towpreg or the output of a resin impregnation line. To form an FBB preform, the bundle of resin-impregnated fibers is cut into segments of a desired size. Each FBB preform includes thousands of co-aligned, resin-infused fibers, typically in multiples of one thousand fibers (e.g., 1k, 10k, 24k, etc.). For the SPI use case, the fibers are typically glass fibers, carbon fibers, or aramid fibers. Any of a variety of thermoplastic resins may suitably be used, such as PPS, PAEK, PEKK, and PEEK, as a function of use case. For example, in cases in which operating temperature is fairly high, PEEK may be used. An FBB preform may have any suitable cross-sectional shape (e.g., circular, oval, trilobal, polygonal, etc.), but is most typically circular or oval. For use in conjunction with the invention, the preforms are typically straight, linear segments.

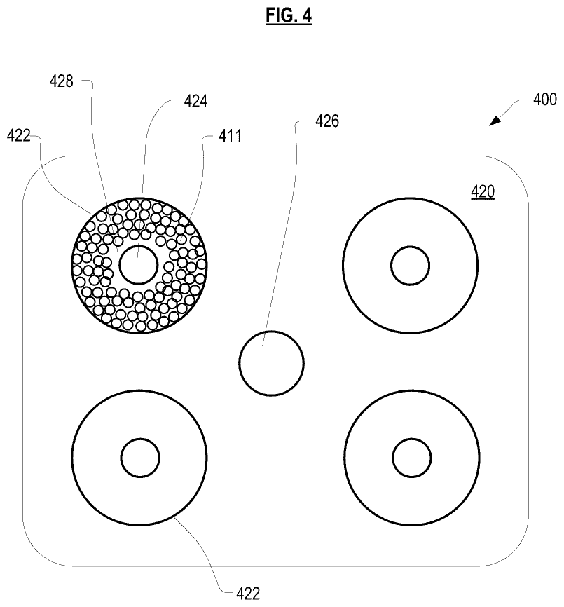

Preform charge 300 is formed using a preform charge fixture, and example of which is depicted in FIG. 4. In the embodiment shown in FIG. 4, preform charge fixture 400 includes four cavities 422 disposed in plate 420. Each cavity 422 has a columnar form, which in the illustrative embodiment has a circular cross section (i.e., the columnar form is “cylindrical”). Each cavity 422 includes core pin 424, which is centrally located, the purpose of which is to create bore 307 in the preform charge. FIG. 4 depicts one of cavities 422 loosely packed with FBB preforms 411; the other cavities 422 are depicted as being empty. During actual production, all cavities 422 would contain FBB preforms 411 to produce multiple instances of preform charge 300. Preform charge fixture 400 can include any (practical) number of cavities 422. Opening 426 in plate 420 receives an alignment pin (not depicted), for aligning plate 420 to a plunger plate (not depicted) having four plungers (in the illustrative embodiment) that cooperate with the four cavities 422.

To create preform charge 300 having a substantially spiral fiber alignment, FBB preforms 411 of a given length are inserted “vertically” into cavities 422 of preform charge fixture 420. Use of the term “vertical” in this context means “axially aligned with the long axis of cavity 422”.

Within cavity 422, there is a small amount of space between FBB preforms 411. In some embodiments, about 3-15% of the cross-sectional area of cavity 422 remains empty, as represented by region 428, even after the requisite amount of FBB preforms 411 are loaded therein. As such, preforms 411 are not fully constrained. More particularly, they can tip slightly in any direction until contacting the closest neighboring FBB preform 411.

After the cavities 422 are filled with FBB preforms 411, each cavity is closed off via a plunger, and preform charge fixture 400 is inserted into a press (not depicted) in which it is pressurized and then heated. Pressure is applied while FBB preforms 411 are still rigid (i.e., their temperature is below the glass transition temperature (Tg) of the resin within the preforms). This pressure is between about 100 to about 500 psi. It will be appreciated that the length of the resulting preform charge is substantially equal to the length of the cavity 422 minus the distance that the plunger (not depicted) extends into the cavity.

Due to the small amount of unoccupied space 428 within cavity 422, the still rigid, vertically-oriented FBB preforms 411 react to the applied pressure by “tipping” towards a neighboring preform. The universal application of pressure to all FBB preforms 411 causes them to tip in a unified direction (i.e., either clockwise or counterclockwise) to achieve maximum packing efficiency. The result of every FBB preform 411 tipping in the same direction around a circular cavity, such as cavity 422, is a spiraled alignment. Similar to imparting a twist to a group of pencils in a jar, rigid FBB preforms 411, complying to the applied pressure, shift into a tighter packing arrangement, exhibiting the aforementioned “twist.” That is, the FBB preforms adopt a substantially spiral arrangement.

After pressurization to create the spiral alignment, the preform charge fixture is heated to a temperature near to or slightly above the resin's melt temperature. This causes the FBB preforms to adhere to one another, and so maintain their “tipped” orientation. As a consequence of this pressurization and heating, the FBB preforms are well amalgamated, but not fully consolidated. It is notable that minimal localized melting occurs; the FBB preforms thus retain their “individuality” in the sense that the fibers associated with a given FBB preform maintain their orientation. The resulting preform charge 300 is then cooled below its glass transition temperature (Tg). Preform charge 300 has the fiber alignment depicted above in FIG. 3 (FBB preforms/fibers angled at about 45 degrees).

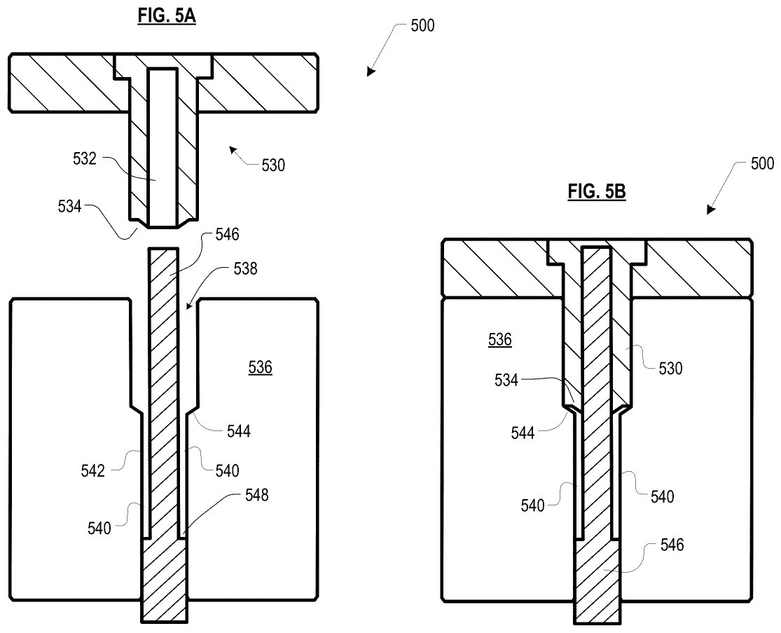

After forming preform charge 300, the SPI is formed via compression molding. To do so, the preform charge is inserted into a compression mold tool that is shaped to produce the fiber-composite SPI. FIGS. 5A and 5B depict an embodiment of a compression-molding tool 500 appropriate for fabricating an SPI, such as SPI 206, in accordance with the present teachings. Molding tool 500 includes plunger or “A-side” 530 and “B-side” 536. FIG. 5A depicts molding tool 500 fully open, and FIG. 5B depicts molding tool fully closed out, with plunger 530 fully extended into B-side 536 of the molding tool.

Plunger 530 includes bore 532, for receiving core pin 546 of B-side 536. B-side 536 includes plunger cavity 538, mold cavity 540, and core pin 546. Mold cavity 540 is defined, primarily, by vertical wall 542, outwardly tapering wall 544, and marginal wall 548 of core pin 546 (and a portion of the exterior surface of the core pin 546). When plunger 530 is fully extended into plunger cavity 538, its marginal lower surface 534 forms the top of mold cavity 540, defining the shape of the SPI being formed.

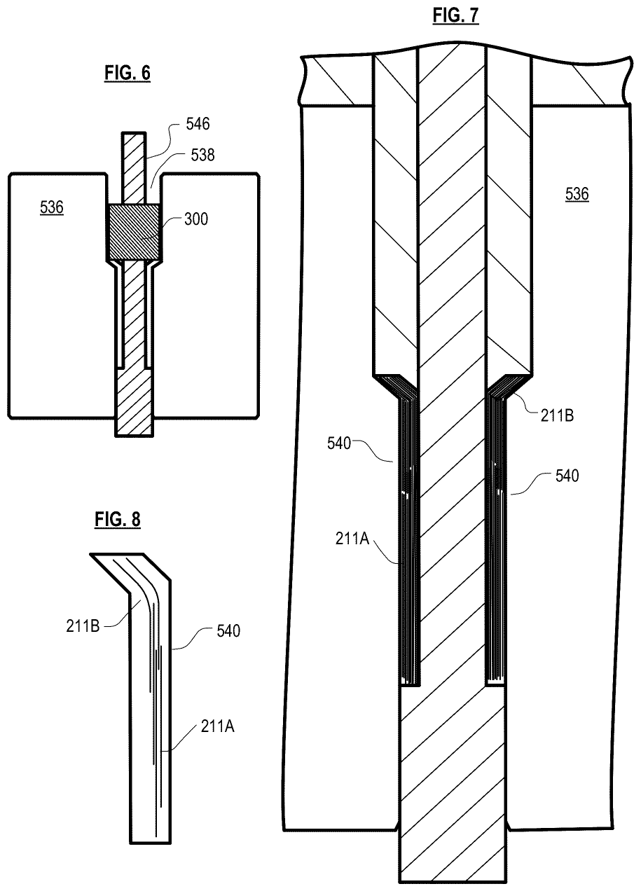

FIG. 6 depicts B-side 536 of molding tool 500 with preform charge 300 inserted into plunger cavity 538, wherein the preform charge accepts core pin 546 within its bore 307 (FIG. 3). After preform charge 300 is placed in B-side 536, plunger 530 is inserted into plunger cavity 538.

During the compression-molding process, heat and pressure are applied to molding tool 500 and, hence, preform charge 300, in accordance with compression molding protocols. Such protocols, as applied to embodiments of the invention, involve pressurization to a pressure in a range of between about 500 psi to about 1000 psi, and heating to a temperature above the melt-flow temperature of the resin in preform charge 300. That temperature is, of course, a function of the particular thermoplastic resin used, and is typically in a range of about 150° C. to about 400° C. As the resin reaches its melt flow state, plunger 530 advances further into plunger cavity 538, eventually reaching the end of its stroke and fully “closing out” (i.e., maximal insertion). Elevated temperature and pressure are typically maintained for a few minutes, to ensure that the resin and fibers from the preform charge are fully consolidated (i.e., to yield an appropriately low void fraction for a finished part). After the aforementioned dwell at temperature and pressure, mold 500 is cooled, and then depressurized. The mold is then opened and finished fiber composite SPI 206 (FIG. 2) is removed from the molding tool.

During the compression-molding process, some fibers 211A from preform charge 300 flow directly downward into mold cavity 540, forming the straight, tubular portion of the SPI. The fibers that flow downwardly are straightened (axially aligned) due to the prevailing flow vectors of liquified resin, as caused by the compression-molding process.

Given the geometric specifications of preform charge 300, the end of the plunger stroke occurs concurrently with the liquified resin flow front reaching the bottom of mold cavity 540. The tapered head of the SPI is formed by bottom marginal surface 534 in conjunction with outwardly tapering wall 544 of mold cavity 540, and thus does not require resin or fiber to flow in order to fill this region of the mold cavity. Consequently, the spiral orientation of the fibers, as first established in preform charge 300, is maintained in head 210 of SPI 206. The mold is then cooled below the resin's Tg, and the finished insert part is ejected.

FIG. 7 depicts a partial view of molding tool 500, showing mold cavity 540 filled with fibers (and resin) from preform charge 300. It is notable that all fibers (211A and 211B) originate from preform charge 300; the suffix “A” or “B” denotes whether a fiber 211 from preform charge 300 flowed fully into the straight body of mold cavity 540 (fibers 211A), or whether the upper portion of a fiber remains in the tapered upper region of mold cavity 540 (i.e., fibers 211B). FIG. 8 depicts an enlargement of mold cavity 540 of FIG. 7, depicting a few fibers 211A and 211B in mold cavity 540.

It is notable that the length of the FBB preforms, and the inner diameter and outer diameter of preform charge 300 formed therefrom, are dependent upon the final part geometry, and are realized through the dimensions of cavity 422 of preform charge fixture 400 (FIG. 4). Specifically, preform charge 300 and the length of the FBB preforms composing it are sized so that at the bottom of the compression stroke (i.e., when the molding tool fully closes out during molding), the resin flow front just reaches the bottom of mold cavity 540, as noted above. If the resin flow were to reach the bottom of cavity 540 before close out of the mold tool, resin flow resulting from the remaining mold close out would flow material further downwardly. This would “squish” the fibers that had already reached the bottom of mold cavity 540, disrupting the axial alignment of the fibers near the bottom of the tubular portion of SPI 206. It is within the capabilities of those skilled in the art, in light of the present disclosure, to design and fabricate FBB preforms, a preform-charge fixture, a preform charge, and a compression molding tool suitable for fabricating an SPI in accordance with the present teachings.

Example. This example provides, for a specific embodiment consistent with the present teachings, actual dimensions of FBB preforms, a preform charge, a preform charge fixture, a molding tool, and the resulting SPI.

### Preforms:

diameter=1.1 mm
length=20 mm

### Preform Charge:

outer diameter=≈13 mm
inner diameter=≈5.5 mm
length=≈10 mm

### Preform-Charge Fixture:

cavity diameter=13.2 mm
outer diameter (of center pin)=5.3 mm

### Molding Tool*:

plunger length=40 mm
plunger cavity length=25.5 mm
core pin diameter=5.2 mm
outer diameter of mold cavity=8.5 mm

### SPI:

outermost diameter of tapered head=13.2 mm
outer diameter of cylindrical body=8.5 mm
inner diameter of cylindrical body=5.2 mm
length of head region=2.2 mm
length of cylindrical region=29.6 mm

*The length of the mold cavity is substantially equal to the overall length of the SPI (length of the head region plus the length of the cylindrical region), as is evident from FIG. 7.

What is claimed:

1. An article comprising a sandwich panel insert, the sandwich panel insert having a monolithic structure comprising a cylindrical body and a tapered head, wherein an axially aligned bore extends completely through the sandwich panel insert, the monolithic structure comprising a plurality of fibers in a resin matrix, wherein a first group of the plurality of fibers are disposed in the tubular body and have an axial alignment therein, and a second group of the plurality of fibers are disposed at least partially in the tapered head and have a spiral alignment therein.

2. The article of claim 1 wherein the plurality of fibers are selected from the group consisting of glass fibers, carbon fibers, and aramid fibers.

3. The article of claim 1 wherein the resin matrix is a thermoplastic.

4. The article of claim 3 wherein the resin matrix is PEEK.

5. The article of claim 1 wherein the head has a conical shape.

6. The article of claim 1 wherein the article is a sandwich panel, the sandwich panel comprising two face sheets and a core, wherein the sandwich panel insert passes through the face sheets and the core.

7. The article of claim 6 wherein the core comprises a honeycomb structure.

8. A method for fabricating a sandwich panel insert having a cylindrical body and a tapered head, the method comprising:
providing a preform charge comprising thermoplastic resin and a plurality of fibers, the preform charge having a cylindrical shape with an axially aligned bore, and composed of a plurality of fiber-bundle-based (FBB) preforms that have a spiral alignment in the preform charge, wherein the resin and plurality of fibers are sourced from the FBB preforms;
placing the preform charge in a plunger cavity of a compression molding tool, the compression molding tool including a core pin that extends through the plunger cavity and receives the preform charge via the axially aligned bore thereof; and
compression molding the preform charge via the application of pressure and heat sufficient to fully liquefy the resin, causing the resin and a first group of fibers of the plurality thereof to flow into an annular mold cavity formed between an inner wall of the compression molding tool and a surface of the core pin and adopt a substantially axially aligned orientation therein, and a second group of fibers, each fiber of the second group remaining partially in a tapered head region of the annular mold cavity and having a spiral orientation in the tapered head region.

9. The method of claim 8 wherein providing the preform charge comprises forming the preform charge by:
a) placing the plurality of FBB preforms in a cavity of a preform-charge fixture, wherein the cavity has a cylindrical shape and a centrally located pin extending upwardly from a bottom of the cavity, wherein the FBB preforms are arranged vertically in the cavity, wherein, based on a number of FBB preforms in the cavity and a cross-sectional area of the cavity, void space remains, such that the FBB preforms are not tightly packed within the cavity;
b) advancing a plunger into the cavity, thereby pressurizing the FBB preforms and causing the FBB preforms to tilt in a uniform direction within the cavity as a consequence of the void space, resulting in a spiral alignment of the FBB preforms;
c) heating the preform-charge fixture to a temperature that results in localized liquefication of the resin in the FBB preforms, thereby amalgamating but not fully consolidating the FBB preforms; and
d) cooling the amalgamated FBB preforms to a temperature below the glass transition temperature of the resin, thereby forming the preform charge.

10. The method of claim 9 wherein the void space is in a range of about 3 to about 15 percent of a cross-sectional area of the cavity.

11. The method of claim 8 wherein compression molding the preform charge comprises advances a plunger in the plunger cavity, the plunger pressurizing the preform charge.

12. The method of claim 11 wherein during compression molding the preform charge, an end of a stroke of the plunger occurs currently with fully liquefied resin reaching a bottom of the annular mold cavity.

13. The method of claim 11 wherein compression molding the preform charge comprises forming the tapered head by coordinating an end of a stroke of the plunger with the liquefied resin reaching a bottom of the annular mold cavity, the bottom of the plunger having a tapered shape that cooperates with the tapered head region of the molding cavity to form the tapered head of the sandwich panel insert.
